(19) United States
(12) Patent Application Publication
(10) Pub. No.: US 2008/0003982 A1
(43) Pub. Date: Jan. 3, 2008

(54) Information processing apparatus and method of controlling the same

(76) Inventor: Hajime Gushiken, Fussa-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/821,166

(22) Filed: Jun. 22, 2007

(30) Foreign Application Priority Data
Jun. 30, 2006 (JP) 2006-182189

(51) Int. Cl. H04M 1/66

(52) U.S. Cl. 455/411

(57) ABSTRACT

According to one embodiment, an information processing apparatus, includes an information processing apparatus, comprises a first wireless communication unit, and a second wireless communication unit, a storage unit configured to store device information of a predetermined communication apparatus capable of carrying out communications by the second wireless communication unit, detection means for detecting the communication apparatus by the second wireless communication unit, in accordance with the device information, means for, if the communication apparatus is detected by the detection means, receiving authentication information for connection to a predetermined carrier communication network, stored in the communication apparatus, via the second wireless communication unit, means for connecting to the predetermined carrier communication network via the first wireless communication unit with the received authentication information.

### CROSS-REFERENCE TO RELATED APPLICATIONS

This application is based upon and claims the benefit of priority from Japanese Patent Application No. 2006-182189, filed Jun. 30, 2006, the entire contents of which are incorporated herein by reference.

### BACKGROUND

1. Field

One embodiment of the invention relates to the present invention relates to an information processing apparatus and a method of controlling the same, capable of temporarily using a communication line of another carrier by receiving SIM information from a preliminarily registered communication device by wireless means.

2. Description of the Related Art

In general, a cellular telephone or information device which uses a card (SIM card) storing SIM (Subscriber Identity Module) information is connected to a communication line of a contracted carrier by using authentication information in the SIM card. As for use of a plurality of authentication information items, for example, JP-A No. 2003-244290 (KOKAI) discloses a technique employing a communication terminal configured to receive predetermined SIM information from an apparatus storing a plurality of SIM information items by wireless means and conduct communications with a carrier corresponding to the received SIM information (cf. JP-A No. 2003-244290 (KOKAI)). According to this technique, however, an apparatus storing a plurality of SIM information items is required. Since this apparatus merely stores the SIM information and sends signals to a predetermined terminal without connecting with a predetermined carrier communication network, introduction of the apparatus costs much and setting operations of the apparatus are complicated.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary illustration showing an information processing apparatus according to an embodiment of the present invention and a communication terminal capable of sharing SIM information with the information processing apparatus; according to an embodiment of the invention;

FIG. 2 is an exemplary flowchart of an initial setting of a cellular telephone terminal; according to the embodiment;

FIG. 3 is an exemplary flowchart of an initial setting of a computer; and according to the embodiment; and

FIG. 4 is an exemplary flowchart of a method of sharing SIM information by the cellular telephone terminal and the computer; according to the embodiment.

### DETAILED DESCRIPTION

Various embodiments according to the invention will be described hereinafter with reference to the accompanying drawings. In general, according to one embodiment of the invention, an information processing apparatus, comprises: a first wireless communication unit; a second wireless communication unit; a storage unit configured to store device information of a predetermined communication apparatus capable of carrying out communications by the second wireless communication unit; detection means for detecting the communication apparatus by the second wireless communication unit, in accordance with the device information; means for, if the communication apparatus is detected by the detection means, receiving authentication information for connection to a predetermined carrier communication network, stored in the communication apparatus, via the second wireless communication unit; means for connecting to the predetermined carrier communication network via the first wireless communication unit with the received authentication information.

An embodiment of the present invention will be described below with reference to the accompanying drawings.

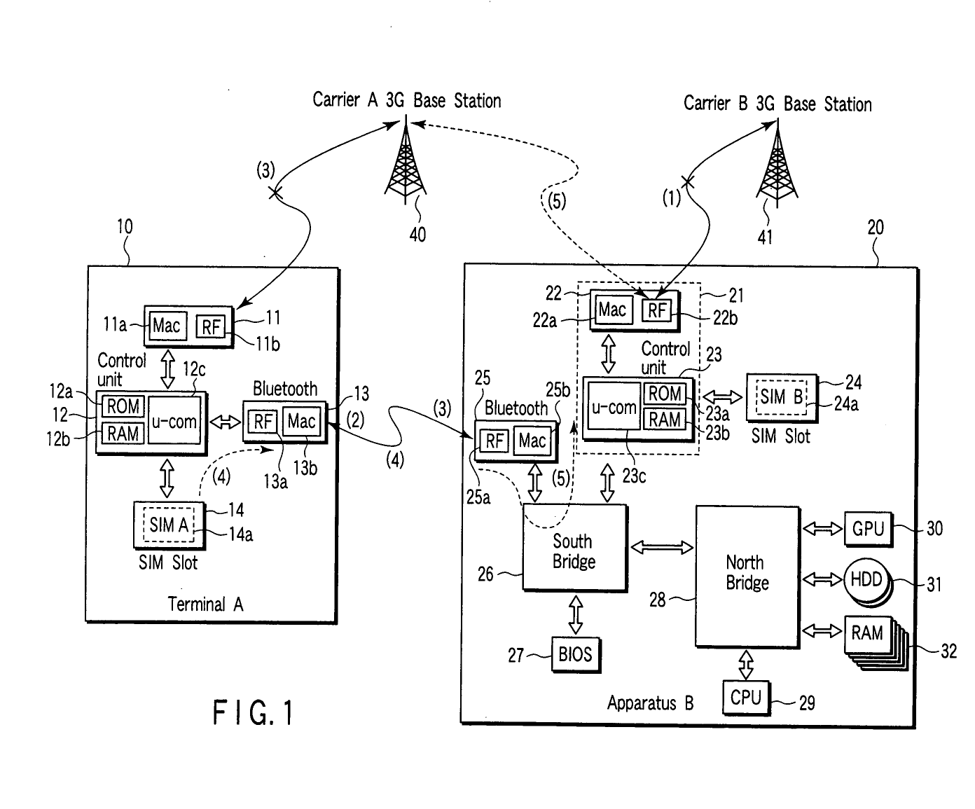

FIG. 1 is an illustration showing an information processing apparatus according to an embodiment of the present invention and a communication terminal capable of sharing SIM (Subscriber Identity Module) information with the information processing apparatus.

The information processing apparatus is implemented as a battery-operated notebook computer 20. The communication terminal is implemented as a cellular telephone terminal 10.

As shown in FIG. 1, the computer (apparatus B) 20 comprises a 3G network unit (first wireless communication unit) 21 which is a communication device configured to connect to carrier B (for example, third-generation communication network of a cellular telephone company B) such as a modem card of a 3G (third generation) network, a SIM card (SIM B card) 24a which stores authentication information (SIM information) required for the communication with the carrier B and which is inserted into a SIM slot 24, a Bluetooth (™) communication device (hereinafter also called BT I/F (interface): second wireless communication unit) 25 configured to conduct close-range wireless communication with the cellular telephone terminal 10, a south bridge 26, a BIOS 27 connected to the south bridge 26, a north bridge 28, a CPU (Central Processing Unit) 29 connected via the north bridge 28, a GPU (Graphic Processing Unit) 30, a HDD (hard disk drive) 31 which stores the operation system, various kinds of applications, utility programs, a RAM 32 and the like.

The 3G network unit 21 comprises a control unit 23 and a wireless unit 22. The control unit 23 comprises, for example, a ROM 23a, a RAM 23b and a u-com 23c. The wireless unit 22 comprises a Mac 22a and a RF (radio frequency circuit) 22b. The Bluetooth (™) communication device (BT I/F) 25 comprises a Mac 25b and a RF (radio frequency circuit) 25a. The wireless unit 22 is connected with a base station 41 of a third-generation communication network of the cellular telephone company B.

The cellular telephone terminal (apparatus A) 10 comprises a wireless unit 11, a control unit 12, a BT I/F 13, a SIM card (SIM A card) 14a inserted into a SIM slot 14, and the like. The wireless unit 11 is connected with a base station 40 of a third-generation communication network of a cellular telephone company A.

The wireless unit 11 comprises Mac 11a and a RF (radio frequency circuit) 11b. The BT I/F 13 comprises a RF (radio frequency circuit) 13a and a Mac 13b. The control unit 12 comprises a ROM 12a, a RAM 12b and a u-com 12c.

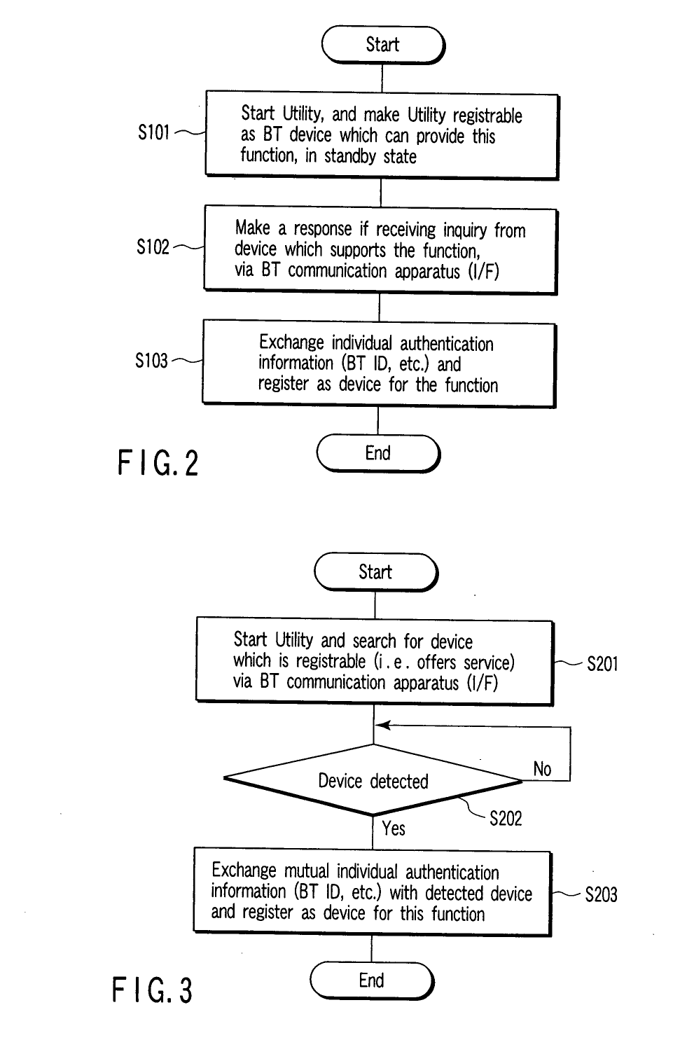

Next, a control method to which the information processing apparatus according to the embodiment of the present invention is applied is described with reference to flowcharts of FIG. 2 to FIG. 4.

FIG. 2 is a flowchart of an initial setting of the cellular telephone terminal (apparatus A) 10. The initial setting is to preliminarily register in the computer 20 device information (for example, BT ID, and the like) of the cellular telephone terminal 10 comprising a SIM information lending function and to register the information of the computer 20 in the cellular telephone terminal 10.

The control unit 12 of the cellular telephone terminal 10 starts utility stored in the ROM 12a to allow the device corresponding to the SIM information lending function to be in a standby state in which the device can be registered as the BT device (block S101). In a case where the control unit 12 receives an inquiry from the device corresponding to the SIM information lending function such as the computer 20 via the BT I/F 13, the control unit 12 responds to the inquiry (block S102). When the control unit 12 of the cellular telephone terminal 10 receives an inquiry from the control unit 12, the control unit 12 exchanges, for example, the BT I/F via the I/F 13 as individual authentication information and registers the device information of the computer 20 in the cellular telephone terminal 10 (block S103). Thus, the initial setting of the cellular telephone terminal 10 is ended.

FIG. 3 is a flowchart of an initial setting of the computer (apparatus B) 20.

The CPU 29 of the computer 20 starts, for example, utility stored in the HDD 31 and locates the BT device corresponding to the SIM information lending function via the BT I/F 25 (block S201). When the CPU 29 of the computer 20 detects the BT device corresponding to the SIM information lending function (YES in block S202), the CPU 29 exchanges, for example, BT ID as the individual authentication information via the BT I/F 25 and registers the cellular telephone terminal 10 in the computer 20 (block S203). Thus, the initial setting of the computer 20 is ended. The utility associates the identification information ID of the device in the BT I/F with the SIM information in accordance with the BT standards and manages the data.

In the initial setting, the cellular telephone terminal 10 and the computer 20 register mutual device information, but the device information of the cellular telephone terminal 10 may be merely registered in the computer 20.

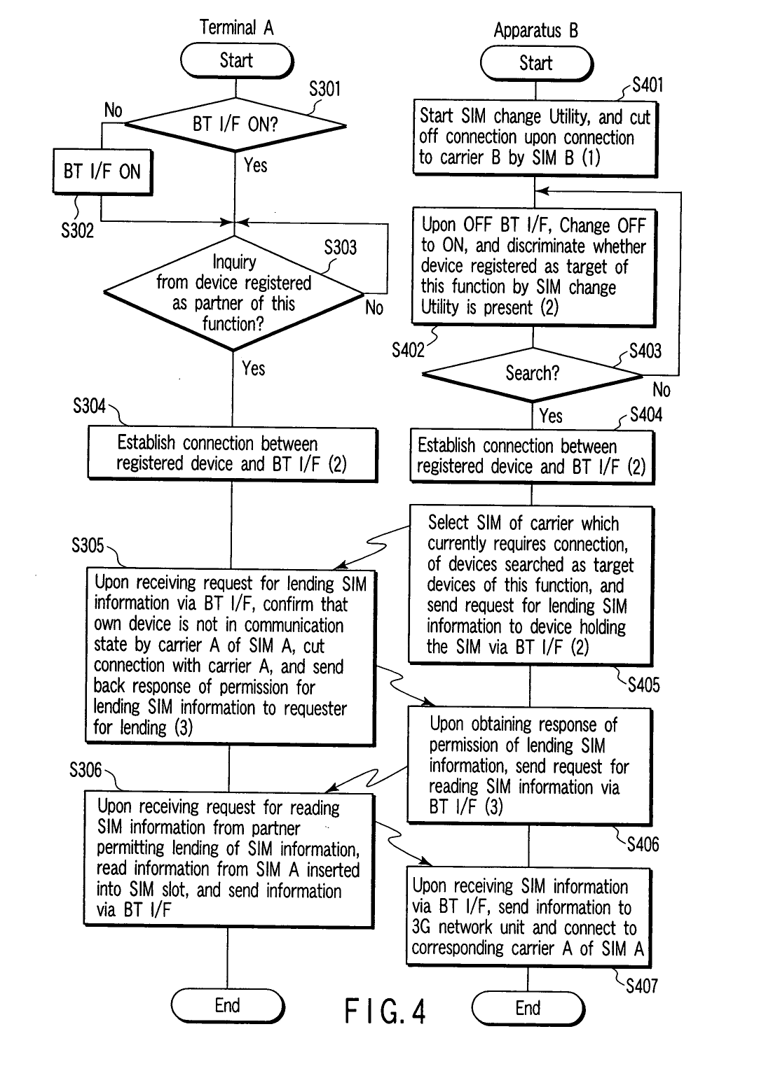

FIG. 4 is a flowchart of a method of lending the SIM information by the cellular telephone terminal 10 and the computer 20.

For example, a process executed by a user who owns the cellular telephone terminal 10 (equipped with SIM A) employing the carrier communication network (mobile communication network) A and the carrier B computer 20 (equipped with SIM B) is described below. The user executes data communication by the computer 20 by employing carrier B in accordance with the contents signed with SIM B, in a generally employed area. However, since the unit price of the communication packet of the contract signed with SIM A is cheap, for example, after 7 o'clock in the afternoon, SIM B is changed to SIM A employing the carrier A and data communication is conducted by the computer 20.

In the above case, the CPU 29 of the computer (apparatus B) 20 starts the utility for changing the SIM information employed in the computer 20. At this time, when the computer 20 is connected to the carrier B by the SIM B, the connection is cut off ((1) in FIG. 1: block S401). The utility discriminates whether the cellular telephone terminal 10 exists in the vicinity as the BT device equipped with the SIM A which has already been usable, via the BT I/F 25. If the BT I/F 25 is OFF, the utility urges the BT I/F 25 to be ON ((2) of FIG. 1: block S402).

On the other hand, the control unit 12 of the cellular telephone terminal 10 (apparatus A) discriminates whether or not the BT I/F 12 is ON (block S301). If the BT I/F 12 is not ON, the control unit 12 urges the BT I/F 25 to be ON (block S302). Then, the control unit 12 discriminates whether or not there is an inquiry from the registered BT device which is the counterpart of the SIM information lending function (block S303).

If the utility of the computer 20 searches for the cellular telephone terminal 10 serving as the BT device equipped with the SIM A which has already been usable, in the vicinity (YES in block S403), the utility establishes the connection with the cellular telephone terminal 10 serving as a registering device via the BT I/F 25 ((2) of FIG. 1: block S404). Similarly to this, the cellular telephone terminal 10 also establishes the connection with the registered computer 20 via the BT I/F 12 ((2) of FIG. 1: block S304).

The computer 20 selects the SIM (for example, SIM A) of the carrier which currently wishes connection, of the cellular telephone terminals 10 which are found as the devices for the SIM information lending function, and makes a request for lending the SIM information to the cellular telephone terminal 10 via the BT I/F 25 ((2) of FIG. 1: block S405).

When the connection is established, the cellular telephone terminal 10 receives the request for lending the SIM information via the BT I/F 12, cuts off the connection to the carrier A after confirming that the cellular telephone terminal 10 is not in the communication state at the carrier A of the SIM A, and sends back a response of permission of lending the SIM information to the requester ((3) of FIG. 1: block S305).

When the computer 20 receives the response of permission of lending the SIM information from the cellular telephone terminal 10, the computer 20 sends a request for reading the SIM information to the cellular telephone terminal 10 via the BT I/F 25 ((3) of FIG. 1: block S406).

When the cellular telephone terminal 10 receives the request for reading the SIM information from the computer 20 which permits lending the SIM information, the cellular telephone terminal 10 reads the information from the SIM A24a inserted into the SIM slot 24 and sends the information via the BT I/F 25 ((4) of FIG. 1: block S306).

When the computer 20 receives the SIM information via the BT I/F 25, the computer 20 sends the received information to the 3G network unit 21 and connects to the carrier A corresponding to the SIM A ((5) of FIG. 1: block S407).

For example, if the user sets telephone outgoing and incoming calls after 7 o'clock in the afternoon to be received on the basis of the contents of the contract signed for the SIM B, the computer 20 cuts off the connection to the carrier under contract of the SIM B and transfers the information of the SIM B to the cellular telephone terminal 10. If such a setting is not conducted, the cellular telephone terminal 10 is set in a state of not being equipped with the SIM and becomes in a power saving mode.

The computer 20 receiving the information of the SIM A connects to the mobile communication network based on the information of the SIM A, and conducts data communication. The cellular telephone terminal 10 receiving the information of the SIM B connects to the mobile communication network based on the information of the SIM B, and becomes in a standby state. The carriers (mobile communication networks) of the SIM A and the SIM B may not be the same.

As a result, by employing the present embodiment, communication devices comprising device configurations capable of individually conducting communications can exchange information stored in the mutual SIM cards and the like and mutually connect to the communication networks to which the respective communication devices belong. Therefore, the management of the SIM information can be facilitated and the direct connection to the communication network which is usable under each condition can be selected.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a first wireless communication unit;
a second wireless communication unit;
a storage unit configured to store device information of a predetermined communication apparatus capable of carrying out communications by the second wireless communication unit;
detection means for detecting the communication apparatus by the second wireless communication unit, in accordance with the device information;
means for, if the communication apparatus is detected by the detection means, receiving authentication information for connection to a predetermined carrier communication network, stored in the communication apparatus, via the second wireless communication unit; and
means for connecting to the predetermined carrier communication network via the first wireless communication unit with the received authentication information.

2. The apparatus according to claim 1, wherein the first wireless communication unit is configured to carry out communications with a carrier communication network of a cellular telephone company, and the authentication information is stored in a SIM card of the communication apparatus.

3. The apparatus according to claim 2, further comprising a storage unit configured to store the other authentication information for communication with a carrier communication network other than the carrier communication network.

4. The apparatus according to claim 3, wherein the received authentication information and the other authentication information are mutually used exclusively.

5. The apparatus according to claim 1, wherein if the communication apparatus sends signals to the information processing apparatus, the communication apparatus suspends a function for communication with the first wireless communication unit.

6. The apparatus according to claim 1, wherein if the storage means stores the device information of the predetermined communication apparatus, the storage unit receives and stores the device information from the communication apparatus by the second wireless communication unit.

7. The apparatus according to claim 1, wherein the second wireless communication unit is close-range wireless communication means.

8. A method of controlling an information processing apparatus,
the apparatus comprising:
a first wireless communication unit;
a second wireless communication unit;
a storage unit configured to store device information of a predetermined communication apparatus capable of carrying out communications by the second wireless communication unit; and
detection means for detecting the communication apparatus by the second wireless communication unit, in accordance with the device information,
the method comprising:
receiving authentication information for connection with a predetermined carrier from the second wireless communication unit provided in the communication apparatus if the communication apparatus is detected by the detection means; and
connecting with the predetermined carrier via the first wireless communication unit by using the received authentication information.

9. The method according to claim 8, wherein the first wireless communication unit is configured to carry out communications with a carrier communication network of a cellular telephone company, and the authentication information is stored in a SIM card of the communication apparatus.

10. The method according to claim 9, further comprising a storage unit configured to store the other authentication information for communication with a carrier communication network other than the carrier communication network.

11. The method according to claim 10, wherein the received authentication information and the other authentication information are mutually used exclusively.

12. The method according to claim 8, wherein if the communication apparatus sends signals to the information processing apparatus, the communication apparatus suspends a function for communication with the first wireless communication unit.

13. The method according to claim 8, wherein if the storage unit stores the device information of the predetermined communication apparatus, the storage means receives and stores the device information from the communication apparatus by the second wireless communication unit.

14. The apparatus according to claim 8, wherein the second wireless communication unit is close-range wireless communication means.
